(19) United States
(12) Patent Application Publication
(10) Pub. No.: US 2007/0285806 A1
(43) Pub. Date: Dec. 13, 2007

(54) Mirror system for a trucking rig having a tractor and an articulated trailer

(76) Inventor: Harry Andrew Beale, Charlotte, NC (US)

Correspondence Address: ARMSTRONG, KRATZ QUINTOS, HANSON & BROOKS, LLP, 520 Washington Avenue, Suite 220, Towson, MD, 21204, US

(21) Appl. No.: 11/451,952

(22) Filed: Jun. 13, 2006

(51) Int. Cl. G02B 5/08

(52) U.S. Cl. 359/843; 359/871

(57) ABSTRACT

A mirror system for a tractor with an articulated trailer includes a mirror housing. The mirror housing is attached to the front end of the tractor on the passenger side. The mirror housing has a planar mirror. The planar mirror is adapted to move. The planar mirror moves allowing continuous observation of the passenger side rear corner of the trailer by a driver.

### FIELD OF INVENTION

The instant application relates to a mirror system for a trucking rig having a tractor and an articulated trailer.

### BACKGROUND OF THE INVENTION

Trucking rigs having a tractor and an articulated trailer present many obstacles when it comes to the vision of the driver or what the driver can see while driving. Trucking rigs having a trailer can not use the usual automobile rearview mirror (mounted on the inside of the windshield) because all the driver would see is the front of the trailer. To make up for the lack of rearview mirrors, each tractor is outfitted with an assortment of side-view mirrors. These side-view mirrors aid the driver in seeing what is behind and beside them.

Side-view mirrors on a trucking rig with a tractor and an articulated trailer are located on both the passenger and driver side of the tractor to see a line of sight down the passenger and driver side of the trailer to the rear corner of the trailer. Large rectangular planar mirrors, or flat mirrors, are fastened to the door on both sides of the tractor. Because these mirrors are planar, they provide an accurate view of how close or how far away things are to the trucking rig, but they have a restricted field of view. To increase the field of view, one or more convex mirrors are attached to the tractor. These mirrors are excellent for informing the driver of potential problems because they have a widened field of view, but are very inexact because they distort distances. Thus, convex mirrors should not be used to determine how close or how far away something is to the trucking rig

A critical use of side-view mirrors on a trucking rig occurs when the trucking rig is being backed into a position. When a driver needs to back the trailer into a position (for loading, parking, etc) the driver maintaining a line of sight to the rear corners of the trailer is very important for safety concerns. It is also very important that the driver has an accurate view of distance to the rear of the trailer to show the driver how close or how far things are to the back of the trailer. Thus, the driver must rely on the planar mirror when backing.

When backing, the angle of the tractor to the trailer deviates to allow the trucking rig to maneuver into a position. The angle of the tractor to the trailer can go from straight to slightly past ninety (90) degrees. This deviation in angle causes the line of sight out of the planar mirrors down the driver and passenger side of the trailer to disappear, preventing a driver to view the rear corners of the trailer.

If a driver has a choice when backing, the driver will approach the problem such that the area into which the trailer is to be backed is to the driver side of the tractor. The planar mirrors on the driver side will only show the position of the driver side rear corner of the trailer for a limited time, as the angle between the tractor and the trailer approaches 90 degrees on the driver side. Thus, the driver loses sight of the driver side rear corner of the trailer. Because the driver initially approached the turn on the driver side of the truck, when the driver loses sight of the driver side rear corner of the trailer in the planar mirror, they can simply look out the door window and see the driver side rear corner of the trailer.

Sometimes the driver simply cannot setup the backing situation on the driver side, and the driver must setup the backing on the passenger side. This setup is not preferred but might occur for many reasons, like the parking area being too small or building arrangements. When the backing must be done to the passenger side, the maneuver is known as blind side backing. This maneuver is very dangerous to the equipment in the driver's charge as well as any other equipment they must maneuver around, including the walls of the building. When blind side backing, the angle of the trailer approaches 90 degrees on the passenger side, thus, the passenger side rear corner of the trailer disappears from view in the planar mirror on the passenger door.

Because the driver cannot easily look out the passenger side door window and see the passenger side rear corner of the trailer, the driver is typically presented with two choices. First, the driver might ask another party to spot for them. Unless the spotter is another driver, this is often very unsatisfactory, because most lay people are unfamiliar with distances required for effecting maneuvers of long trailers. The other choice is for the driver to get out of the truck and walk around to the passenger side and ascertain the situation. Both of these choices result in wasted time and added danger in backing the trucking rig.

Some known systems to solve the blind side backing problems involve a motorized planar mirror for use on the passenger side door of the tractor. This is an improvement because it allows the driver to adjust the planar mirror to display the changing angles of the trucking rig. However, as the angle between the tractor and trailer approaches 90 degrees, the plane of the mirror is almost parallel to the driver, forcing the apparent view through the planar mirror to diminish. This means the driver can see very little, if anything. Again, the driver must get a spotter or get out of the truck and walk around to the passenger side to ascertain the situation.

Another problem that drivers face when backing is lack of illumination during the evening or nighttime. Most trucking rigs are equipped with reverse lights at the back of the tractor to illuminate what is behind the tractor. These lights are ineffective with respect to revealing any useful information about the trailer. This makes the objects in the passenger side mirrors very hard to see and makes maneuvering around the objects very dangerous.

Accordingly, there is a need for a mirror system that addresses all of these problems.

### SUMMARY OF THE INVENTION

The instant invention is a mirror system for a tractor with an articulated trailer. The mirror system includes a mirror housing. The mirror housing is attached to the front end of the tractor on the passenger side. The mirror housing has a planar mirror. The planar mirror is adapted to move. The planar mirror moves allowing continuous observation of the passenger side rear corner of the trailer by a driver.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an elevated view of one embodiment of the mirror system.

FIG. 2 is one embodiment of the mirror housing.

FIG. 3 is a top view of the trucking rig with the mirror system of FIG. 1.

FIG. 4 is a top view of the trucking rig with the mirror system of FIG. 1.

### DETAILED DESCRIPTION OF THE INVENTION

Referring to the drawings, wherein like numerals indicate like elements, there is shown in FIGS. (1 and 3-4) a mirror system 10 for a trucking rig 8 having a tractor 12 and an articulated trailer 14. Mirror system 10 generally comprises a mirror housing 16 and a positioner device 30. Mirror system 10 may allow for observation of the passenger side rear corner of trailer 14 by a driver of tractor 12 while backing in lighted or unlighted conditions.

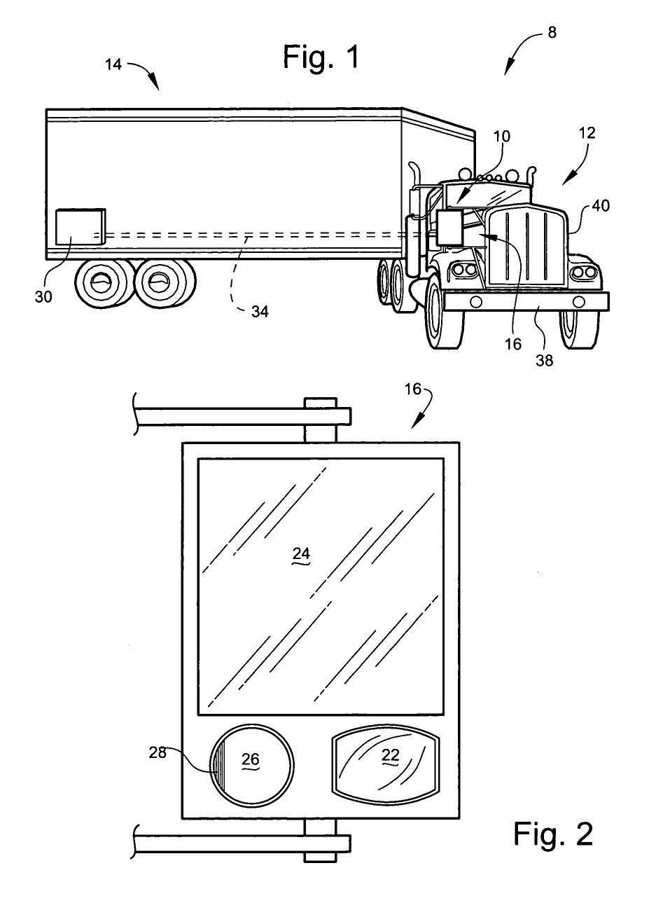

Mirror housing 16 may be attached to the front end of tractor 12 on its passenger side (see FIGS. 1 and 3-4). Mirror housing 16 may have a planar mirror 24. Mirror housing 16 may also include a convex mirror 22, a light 26, and a baffle 28 (see FIG. 2). Mirror housing 16 may be any member capable of holding convex mirror 22, planar mirror 24, light 26, and baffle 28. Mirror housing 16 may be attached to tractor 12 as far to the front of tractor 12 as possible. Mirror housing 16 may be attached to a front fender 38 of tractor 12 and to the front of a hood 40 of tractor 12 (see FIGS. 1 and 3-4). Mirror housing 16 may move planar mirror 24 and light 26 through a motor within mirror housing 16. Mirror housing 16 may have a home position that may be selected by the driver for positioning planar mirror 24 and light 26 when mirror system 10 may be deactivated. Mirror housing 16 may be powered by tractor 12 by connecting a wire to a power source of tractor 12.

Planar mirror 24 may be housed in mirror housing 16 (see FIG. 2). Planar mirror 24 may be adapted to move within mirror housing 16. Planar mirror 24 may allow for viewing the area along the passenger side of trailer 14 all the way to the passenger side rear corner of trailer 14. Planar mirror 24 may move tracking the position of positioner device 30. Planar mirror 24 may provide a reliable view of distance down the passenger side of tractor 12 to the rear corner of trailer 14. Planar mirror 24 may be any type of mirror, including, but not limited to, a flat mirror or a slightly convex mirror.

Convex mirror 22 may be housed in mirror housing 16 (see FIG. 2). Convex mirror 22 may be used to warn the driver of danger on the passenger side of trailer 14. Convex mirror 22 may provide a wider angle of view than a flat mirror. Convex mirror 22 may be any convexly shaped mirror. Convex mirror 22 may be a compound convex mirror. A compound convex mirror may be a mirror that is curved in two perpendicular axes that allows for viewing a wider area in two directions.

Light 26 may be housed in mirror housing 16 (see FIG. 2). Light 26 may be adapted to move within mirror housing 16. Light 26 may move tracking the position of positioner device 30. Light 26 may be for illuminating the area on the passenger side of tractor 12 all the way to the rear corner of trailer 14. Light 26 may be any form of light capable of illuminating the area on the passenger side of tractor 12 all the way to the rear of trailer 14.

Baffle 28 may be housed in mirror housing 16 (see FIG. 2). Baffle 28 may be for blocking light 26 from the view of the driver. Baffle 28 may be any structure capable of blocking light 26 from the view of the driver. Baffle 28 may be a structure built into light 26 (as shown in FIG. 2).

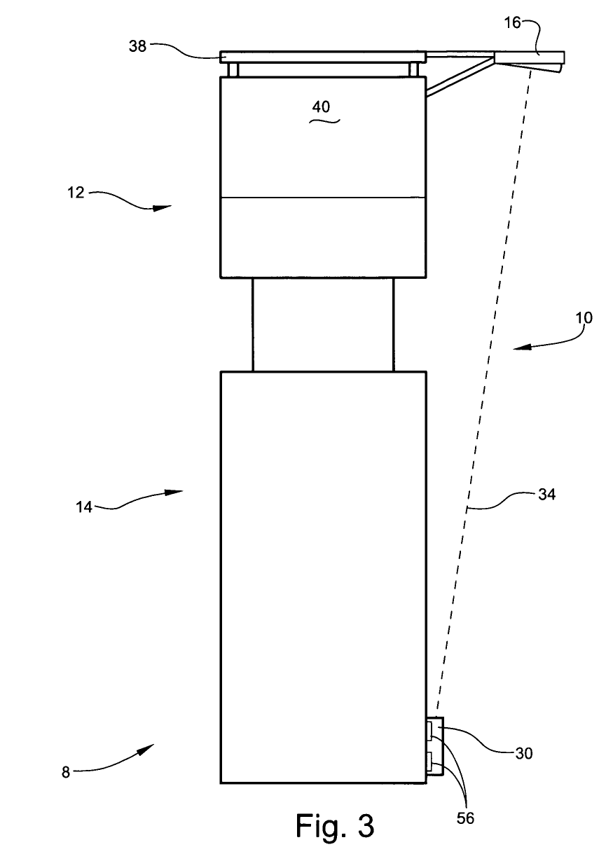

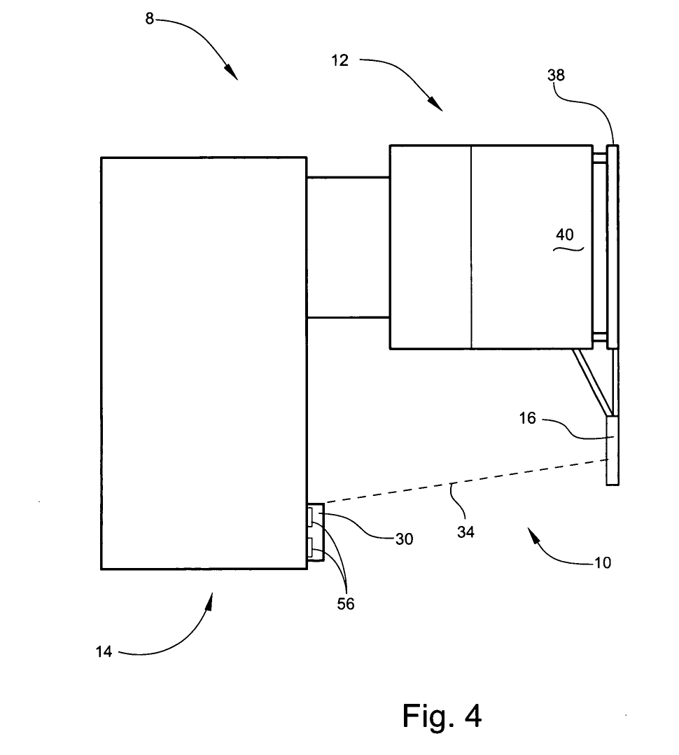

Positioner device 30 may be attached to the rear end of trailer 14 on its passenger side (see FIGS. 1 and 3-4). Positioner device 30 may be for communicating its position to mirror housing 16. Positioner device 30 may be any device capable of communicating its position to mirror housing 16. Positioner device 30 may be any size. Preferably, positioner device 30 may be as small as possible. In FIGS. 1 and 3-4, positioner device 30 is shown in a large size for illustrative purposes. Positioner device 30 may communicate its position to mirror housing 16 through a signal 34. Positioner device 30 may position planar mirror 24 and light 26 based on its position. Positioner device 30 may be attached to trailer 14 by fastener 56 (as shown in FIGS. 3-4) or may be permanently attached to trailer 14. Positioner device 30 may be powered by a small battery or may be powered by power from the electrical system of trailer 14.

Signal 34 may be a signal transmitted from positioner device 30 (see FIGS. 1 and 3-4). Signal 34 may allow for communication between positioner device 30 and mirror housing 16. Signal 34 may be any signal capable of communicating the position of positioner device 30 to mirror housing 16. Signal 34 may be a radio frequency with an encryption. The encryption may be any encryption, including, but not limited to a 16 to 128 bit encryption. The radio frequency encryption may allow positioner device 30 to communicate with mirror housing 16 over a radio frequency that is different from other trucking rigs with mirror system 10. The encryption may reduce the possibility of the radio frequency being confused with another radio frequency.

Fastener 56 may attach positioner device 30 to trailer 14 (See FIGS. 3-4). Fastener 56 may be any means of attaching positioner device 30 securely to trailer 14 that allows positioner device 30 to be easily removed.

In operation, when trucking rig 8 is backed into a position on the passenger side of trucking rig 8, the angle of tractor 12 to trailer 14 may approach 90 degrees on the passenger side (see FIG. 4). The position of positioner device 30 may change with respect to mirror housing 16 as the angle of tractor 12 to trailer 14 changes. As the position of positioner device 30 may change with respect to mirror housing 16, mirror housing 16 may track the position of positioner device 30 through signal 34. Planar mirror 24 may move in response to signal 34 changing the driver's angle of view through planar mirror 24 to always reflect the position of positioner device 30. Because positioner device 30 maintains its position on the rear passenger side of trailer 14, it allows continuous observation by the driver of the passenger side rear corner of trailer 14 through planar mirror 24 to be maintained while trucking rig 8 is backed into position.

As planar mirror 24 may move, light 26 may also move in response to signal 34. Light 26 may move changing the direction light 26 may be aimed to always aim towards positioner device 30. Because positioner device 30 may be located on the rear passenger side of trailer 14 and light 26 tracks the position of positioner device 30, light 26 may aim toward the passenger side rear of trailer 14 and may illuminate the area along and beside trailer 14. This may allow continuous illumination of the area along and beside trailer 14 on the passenger side while trucking rig 8 is backed into position. The combination of planar mirror 24 and light 26 being able to move in response to signal 34 tracking the position of positioner device 30 may allow the driver to maintain a continuous line of sight to the passenger side rear corner of trailer 14 while backing in lighted or unlighted conditions.

When the angle of trailer 14 to tractor 12 approaches 90 degrees on the passenger side, the maximum view through planar mirror 16 may be obtained by positioning mirror housing 16 as far to the front of tractor 12 as possible (see FIGS. 3-4). Mirror housing 16 may be attached to the front fender 38 of tractor 12 and to the front part of hood 40 to be positioned as far to the front of tractor 12 as possible. By positioning mirror housing 16 as far to the front of tractor 12 as possible it may decrease the angle of reflection from the driver to the rear passenger side of trailer 14 through planar mirror 24. The view through planar mirror 24 of the passenger side rear corner of trailer 14 may decrease, but because mirror housing 16 may be attached as far to the front of tractor 12 as possible, the plane of planar mirror 24 will not approach being parallel to the driver. By positioning mirror housing 16 as far to the front of tractor 12 as possible, the angle of reflection through planar mirror 24 from the driver to the passenger side rear corner of trailer 14 may be as small as possible allowing the view through planar mirror 24 to be as large as possible.

Because positioner device 30 may be located at different positions relative to mirror housing 16 and planar mirror 24 and light 26 may still track the position of positioner device 30, mirror system 10 may work with different lengths and sizes of trailers. Thus, when mirror housing 16 may be attached to tractor 12, positioner device 30 may be attached to trailer 14 or any other trailer and mirror system 10 may still function properly. Attaching positioner device 30 by fastener 56 may allow for positioner device 30 to be easily transferred from trailer 14 to another trailer. Positioner device 30 may be powered by a small battery located within positioner device 30. The small battery may eliminate the need to wire positioner device 30 to a power source and may facilitate the transfer of positioner device 30 from trailer 14 to another trailer.

Positioner device 30 may also be permanently attached to trailer 14. Positioner device 30 should be permanently attached to trailer 14 when no trailer other than trailer 14 may be normally used with tractor 12. Positioner device 30 may be powered by tractor 12 by connecting positioner device 30 with the power source of tractor 12. This eliminates the need to change the batteries in positioner device 30.

Mirror system 10 may be in communication with tractor 12. Mirror system 10 may communicate with tractor 12 to determine when mirror system 10 may be activated and deactivated. Mirror system 10 may be activated when tractor 12 is in reverse. Mirror system 10 may be deactivated when tractor 12 is in forward or neutral. When mirror system 10 may be activated, planar mirror 24 and light 26 may move tracking positioner device 30. When mirror system 10 may be deactivated, planar mirror 24 and light 26 may move to the home position and be stationary. In another embodiment of the invention mirror system 10 may have a power switch. The power switch may be used for activating and deactivating mirror system 10. The power switch may be located within tractor 12 allowing the driver to activate and deactivate mirror system 10 while driving.

Mirror system 10 may have a light switch. The light switch may be for turning light 26 on and off. The light switch may be located within tractor 12 allowing the driver to turn light 26 on and off while driving. This may allow the driver the choice of whether he wants light 26 on or off.

In one embodiment of the invention, convex mirror 22 may be adapted to move. Convex mirror 22 may move to provide the driver a wider angle of view when backing. Convex mirror 22 may be powered to move by the same motor that powers planar mirror 24 and light 26. Convex mirror 22 may move in response to signal 34 from positioner device 30 allowing the driver a wider view to the passenger side rear corner of trailer 14 by the driver while backing.

In another embodiment of the invention, planar mirror 24 may be a flexible mirror adapted to reshape to a large convex mirror. Planar mirror 24 may reshape to the large convex mirror for allowing a wider angle of view of the area on the passenger side of tractor 12 to the passenger side rear corner of trailer 14. Providing a wider angle of view of the area on the passenger side of tractor 12 may allow mirror system 10 to work with longer trailers. A reshape switch may be included to reshape planar mirror 24 to the large convex mirror and reshape the large convex mirror back to planar mirror 24. The reshape switch may allow the driver the choice of planar mirror 24 for accurate view of distances or the large convex mirror for a wider angle of view. This wider angle of view may be used for longer trailers. The reshape switch may be located within tractor 12 allowing the driver to reshape planar mirror 24 while driving.

Although mirror system 10 is preferably used on the passenger side of trucking rig 8 because of safety concerns, mirror system 10 may also function on the driver side of trucking rig 8. This is done by mounting mirror housing 16 on the driver side of tractor 12 and attaching positioner device 30 to the driver side rear corner of trailer 14.

The present invention may be embodied in other forms without departing from the spirit and the essential attributes thereof, and, accordingly, reference should be made to the appended claims, rather than to the foregoing specification, as indicated in the scope of the invention.

I claim:

1. A mirror system for a trucking rig having a tractor and an articulated trailer comprising:
a mirror housing comprising a planar mirror;
said mirror housing being attached as far to the front of the tractor as possible on its passenger side;
said planar mirror being adapted to move;
whereby said planar mirror moving to allow continuous observation of the passenger side rear corner of the trailer.

2. The mirror system of claim 1 where said mirror housing being attached to a front fender of said tractor.

3. The mirror system of claim 1 where said mirror housing being attached to the front of a hood of said tractor.

4. The mirror system of claim 1 where said mirror housing being powered by said tractor.

5. The mirror system of claim 1 where said mirror housing further comprising a convex mirror.

6. The mirror system of claim 1 where said mirror housing further comprising a light being adapted to move;
whereby said planar mirror and said light moving to allow continuous observation of the passenger side rear corner of the trailer in lighted or unlighted conditions.

7. The mirror system of claim 6 where said mirror housing further comprising a baffle;
said baffle being adapted to continuously block said light from the vision of the driver.

8. The mirror system of claim 6 further comprising a light switch, said light switch being adapted to turn said light on and off.

9. The mirror system of claim 1 further comprising a positioner device being located at the rear end of the trailer on its passenger side;
said positioner device being in communication with said mirror housing through a signal;
whereby said planar mirror and said light moving in response to said signal tracking the movement of the passenger side rear corner of the trailer and allowing continuous observation of the passenger side rear corner of the trailer by a driver in lighted or unlighted conditions.

10. The mirror system of claim 9 where said positioner device being attached to the trailer by a fastener, said fastener securely attaches said positioner device to the trailer where said positioner device may be easily removed.

11. The mirror system of claim 9 where said positioner device being powered by the tractor.

12. The mirror system of claim 9 where said positioner device being powered by a battery.

13. The mirror system of claim 1 wherein said mirror housing having a home position;
said mirror housing moving said planar mirror and said light to said home position when said mirror system being deactivated.

14. The mirror system of claim 1 wherein said mirror system being in communication with said tractor;
when said tractor being in reverse said mirror system being activated; and
when said tractor being in neutral or forward said mirror system being deactivated.

15. The mirror system of claim 1 further comprising a power switch, said power switch being adapted to activate and deactivate said mirror system.

16. The mirror system of claim 1 where said convex mirror being adapted to move.

17. The mirror system of claim 16 whereby said convex mirror, said planar mirror and said light move in response to said signal tracking the movement of the passenger side rear corner of the trailer and allowing observation of the passenger side rear corner of the trailer by the driver while backing in lighted or unlighted conditions.

18. The mirror system of claim 1 wherein said planar mirror being adapted to reshape to a large convex mirror.

19. The mirror system of claim 18 further comprising a reshape switch, said reshape switch being adapted to reshape said planar mirror to said large convex mirror and reshape said large convex mirror back to said planar mirror.

20. The mirror system of claim 1 wherein said signal being a radio frequency encrypted with a 16 to 128 bit encryption.
